(19) United States
(12) Patent Application Publication
(10) Pub. No.: US 2026/0126622 A1
(43) Pub. Date: May 7, 2026

(54) CAMERA OPTICAL LENS

(71) Applicant: Changzhou AAC Raytech Optronics Co., Ltd., Changzhou City (CN)

(72) Inventor: Ziwei Liu, Changzhou (CN)

(21) Appl. No.: 19/048,867

(22) Filed: Feb. 8, 2025

Related U.S. Application Data
(63) Continuation of application No. PCT/CN2024/129806, filed on Nov. 5, 2024.

(51) Int. Cl. G02B 13/00; G02B 9/34

(52) U.S. Cl. CPC G02B 13/004; G02B 9/34

(57) ABSTRACT

The present disclosure relates to the field of optical lens, and discloses a camera optical lens. The camera optical lens includes from an object side to an image side: a first lens having positive refractive power, a second lens having refractive power, a third lens having positive refractive power, and a fourth lens having negative refractive power; and following relational expressions are satisfied: 0.15≤d6/TTL≤0.25; 0.80≤f1/f≤0.95; 0.97≤TTL/f≤1.20; 4.00≤(R5+R6)/(R5−R6)≤60.00; and 0.30≤d3/d5≤1.20. The camera optical lens of the present disclosure has excellent optical performance, and is particularly suitable for a mobile phone camera lens assembly, and a WEB camera lens composed of camera elements such as CCD, CMOS for high pixels

### TECHNICAL FIELD

The present disclosure relates to the field of optical lenses, and in particular to a camera optical lens suitable for handheld terminal devices such as smart phones, digital cameras, and camera devices such as monitors and PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the photosensitive device is continuously reduced and the requirements on the imaging quality of the system are continuously improved, a structure with four lenses gradually appears in the lens design. There is an urgent need for a camera optical lens having excellent optical performance.

### SUMMARY

In view of the above problems, an object of the present disclosure is to provide a camera optical lens meeting design requirements of excellent optical performance.

In order to solve the above technical problem, the present disclosure provides a camera optical lens. The camera optical lens includes from an object side to an image side: a first lens having positive refractive power, a second lens having refractive power, a third lens having positive refractive power, and a fourth lens having negative refractive power. A focal length of the camera optical lens is defined as f, a total optical length from an object side surface of the first lens to an image plane of the camera optical lens along an optic axis is defined as TTL, a focal length of the first lens is defined as f1, an on-axis thickness of the second lens is defined as d3, an on-axis thickness of the third lens is d5, an on-axis distance from an image side surface of the third lens to an object side surface of the fourth lens is defined as d6, a central curvature radius of an object side surface of the third lens is defined as R5, and a central curvature radius of an image side surface of the third lens is defined as R6, and following relational expressions are satisfied:

$$\begin{matrix}0.15 ⩽ d 6 / TTL ⩽ 0.25 ; \\ 0.8 ⩽ f 1 / f ⩽ 0.95 ; \\ 0.97 ⩽ TTL / f ⩽ 1.2 ; \\ 4. ⩽ ( R 5 + R 6 ) / ( R 5 - R 6 ) ⩽ 60. ; and \\ 0.3 ⩽ d 3 / d 5 ⩽ 1.2 .\end{matrix}$$

As an improvement, a focal length of the fourth lens is f4, and a following relational expression is satisfied:

$$- 1.4 ⩽ f 4 / f ⩽ - 0.9 .$$

As an improvement, a central curvature radius of an object side surface of the fourth lens is defined as R7, a central curvature radius of an image side surface of the fourth lens is defined as R8, and a following relational expression is satisfied:

$$1.5 ⩽ R 7 / R 8 ⩽ 5. .$$

As an improvement, an object side surface of the first lens is convex in a paraxial region, and an image side surface of the first lens is concave in the paraxial region; and
an on-axis thickness of the first lens is defined as d1, a central curvature radius of an object side surface of the first lens is defined as R1, a central curvature radius of an image side surface of the first lens is defined as R2, and following relational expressions are satisfied:

$$\begin{matrix}- 5.64 ⩽ ( R 1 + R 2 ) / ( R 1 - R 2 ) ⩽ - 1.37 ; and \\ 0.06 ⩽ d 1 / TTL ⩽ 0.2 .\end{matrix}$$

As an improvement, a focal length of the second lens is defined as f2, a central curvature radius of an object side surface of the second lens is defined as R3, a central curvature radius of an image side surface of the second lens is defined as R4, and following relational expressions are satisfied:

$$\begin{matrix}- 48.2 ⩽ f 2 / f ⩽ 143.29 ; \\ - 10. 18 ⩽ ( R 3 + R 4 ) / ( R 3 - R 4 ) ⩽ 1.99 ; and \\ 0.02 ⩽ d 3 / TTL ⩽ 0.1 5 .\end{matrix}$$

As an improvement, an object side surface of the third lens is concave in a paraxial region, and an image side surface of the third lens is convex in the paraxial region;
a focal length of the third lens is f3, and following relational expressions are satisfied:

$$\begin{matrix}1.13 ⩽ f 3 / f ⩽ 13.05 ; and \\ 0.03 ⩽ d 5 / TTL ⩽ 0.1 9 .\end{matrix}$$

As an improvement, an object side surface of the fourth lens is convex in a paraxial region, and an image side surface of the fourth lens is concave in the paraxial region;
a central curvature radius of an object-side surface of the fourth lens is R7, a central curvature radius of an image-side surface of the fourth lens is R8, and an on-axis thickness of the fourth lens is d7, and following relational expressions are satisfied:

$$\begin{matrix}0.75 ⩽ ( R 7 + R 8 ) / ( R 7 - R 8 ) ⩽ 6.43 ; and \\ 0.04 ⩽ d 7 / TTL ⩽ 0.22 .\end{matrix}$$

As an improvement, an F-number FNO of the camera optical lens is smaller than or equal to 2.45.

As an improvement, an image height of the camera optical lens is IH, and a following relational expression is satisfied:

$$TTL / IH ⩽ 1.1 6 .$$

As an improvement, a combined focal length of the first lens and the second lens is f12, and a following relational expression is satisfied:

$$0.42 ⩽ f 12 / f ⩽ 1.58 .$$

The present disclosure has following beneficial effects: the camera optical lens as described in the present disclosure has excellent optical performance, and is particularly suitable for a mobile phone camera lens assembly, and a WEB camera lens composed of camera elements such as CCD, CMOS for high pixels.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Example 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a schematic structural diagram of a camera optical lens according to Comparative Example of the present disclosure;

FIG. 22 is a schematic diagram of longitudinal aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EMBODIMENTS

In order to more clearly illustrate objectives, technical solutions, and advantages of embodiments of the present disclosure, the technical solutions in embodiments of the present disclosure are clearly and completely described in details with reference to the accompanying drawings. However, those skilled in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

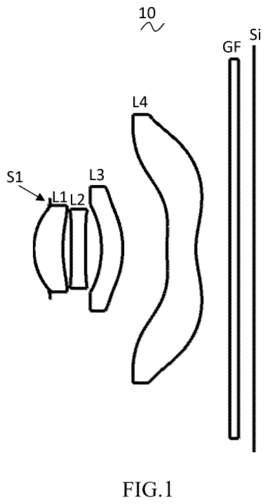

Referring to FIG. 1 to FIG. 20, the present disclosure provides camera optical lenses 10, 20, 30, 40 and 50. FIG. 1, FIG. 5, FIG. 9, FIG. 13, and FIG. 17 show camera optical lenses 10, 20, 30, 40 and 50 according to the present disclosure, and the camera optical lenses 10, 20, 30, 40 and 50 include four lenses in total. The camera optical lens sequentially includes: from an object side to an image side, an aperture S1, a first lens L1, a second lens L2, a third lens L3, and a fourth lens L4. Optical elements such as an optical filter GF may be provided between the fourth lens L4 and the image plane Si.

The first lens L1 has positive refractive power. The second lens L2 has refractive power. The third lens L3 has positive refractive power. The fourth lens L4 has negative refractive power. In other alternative embodiments, the refractive power of the lens may be provided with other positive and negative distributions.

An on-axis distance from the image-side surface of the third lens L3 to the object-side surface of the fourth lens L4 is defined as d6, and the total optical length from the object-side surface of the first lens to an image plane of the camera optical lens along an optic axis is defined as TTL, and a following relational expression is satisfied: 0.15≤d6/TTL≤0.25, which specifies a ratio of a distance between the third lens and the fourth lens to a total optical length. Within a range of the relational expression, it is helpful to buffer changes in an incident angle of the large-view-angle light, making it easier for the large-view-angle light to propagate smoothly in the optical imaging lens assembly, resulting in better imaging quality and lower sensitivity of the camera optical lens.

A focal length of the first lens L1 is defined as f1, and a focal length of the camera optical lens is defined as f, and a following relational expression is satisfied: 0.80≤f1/f≤0.95, which specifies a ratio of the focal length of the first lens L1 and the focal length of the camera optical lens. By reasonably allocating the optical focal length of the camera optical lens, the degree of deviation of light passing through the lens can be alleviated within the above range of the relational expression, effectively correcting chromatic aberration, and making the chromatic aberration |LC|≤7.0 μm.

In addition, the camera optical lens further satisfies a following relational expression: 0.97≤TTL/f≤1.20, which specifies a telescopic ratio, and by letting the telescopic ratio be less than the upper limit value of the relational expression, the TTL can be controlled to be shorter, making it easier to achieve miniaturization. On the other hand, by letting the telescopic ratio be greater than the lower limit value of the relational expression, distortion and on-axis chromatic aberration can be easily corrected, and thus maintaining excellent optical performance.

A central curvature radius of an object side surface of the third lens L3 is defined as R5, a central curvature radius of an image side surface of the third lens L3 is defined as R6, and a following relational expression is satisfied: 4.00≤(R5+R6)/(R5−R6)≤60.00, which specifies a shape of the third lens L3. It is beneficial to correct the astigmatism and distortion of the camera optical lens 10, so that the |Distortion|≤2.5%, thereby reducing the possibility of vignetting.

An on-axis thickness of the second lens L2 is defined as d3, and an on-axis thickness of the third lens L3 is defined as d5, a following relational expression is satisfied: 0.30≤d3/d5≤1.20, which specifies a ratio of the on-axis thickness of the second lens L2 to the on-axis thickness of the third lens L3. Within the above range of the relational expression, it helps compress the total optical length of the camera optical lens.

When the above relational expression is satisfied, the camera optical lenses 10, 20, 30, 40 and 50 have excellent optical performance and may satisfy the design requirements of large aperture, wide-angle and ultra-thinness. According to the characteristics of the camera optical lenses 10, 20, 30, 40 and 50, the camera optical lenses 10, 20, 30, 40 and 50 are particularly suitable for mobile phone camera lens assembly and the WEB camera lens composed of camera elements such as CCD and CMOS for high pixels.

Based on the above relational expressions and the achievable functions, the characteristics of each lens are further defined as follows.

An object side surface of the first lens L1 is convex in a paraxial region, and an image side surface of the first lens L1 is concave in the paraxial region. An object side surface of the third lens L3 is concave in the paraxial region, and an image side surface of the third lens L3 is convex in the paraxial region. An object side surface of the fourth lens L4 is convex in the paraxial region, and an image side surface of the fourth lens L4 is convex in the paraxial region. In other optional embodiments, the object side surface and the image side surface of the above-mentioned lens L2 may also be provided with other concave and convex distributions.

A focal length of the fourth lens L4 is defined as f4, and satisfies the following relational expression: −1.40≤f4/f≤−0.90, which specifies a ratio of the focal length of the fourth lens L4 to the focal length of the camera optical lens 10. By reasonably allocating the optical focal length of the camera optical lens, it can achieve good sensitivity performance while satisfying a design of a large aperture.

A central curvature radius of the object side surface of the fourth lens L4 is R7, and a central curvature radius of the image side surface of the fourth lens L4 is R8, a following relational expression is satisfied: 1.50≤R7/R8≤5.00, which specifies a shape of the fourth lens L4. Within the above range of the relational expression, it is beneficial to alleviate the degree of deflection of light passing through the lens, thereby effectively reducing the aberration.

The central curvature radius of the object side surface of the first lens L1 is R1, and the central curvature radius of the image side surface of the first lens L2 is R2, and a following relational expression is satisfied: −5.64≤(R1+R2)/(R1−R2)≤−1.37, which specifies a shape of the first lens L1. Within the above range of the relational expression, it is beneficial to achieving ultra-wide-angle. Optionally, a following relational expression is satisfied: −3.52≤(R1+R2)/(R1−R2)≤−1.72.

An on-axis thickness of the first lens L1 is d1, and a following relational expression is satisfied: 0.06≤d1/TTL≤0.20. Within the above range of the relational expression, it is beneficial to achieve miniaturization. Optionally, a following relational expression is satisfied:

$$0.10 \leq d 1 / TTL \leq 0.16 .$$

A focal length of the second lens L2 is defined as f2, and a following relational expression is satisfied: −48.20≤f2/f≤143.29, which specifies a ratio of the focal length f2 of the second lens L2 to the focal length f of the camera optical lens. Within the above range of the relational expression, the field curvature of the system may be effectively balanced. Optionally, a following relational expression is satisfied: −30.12≤f2/f≤114.64.

A central curvature radius of an object side surface of the second lens L2 is R3, a central curvature radius of an image side surface of the second lens L2 is R4, and a following relational expression is satisfied: −10.18≤(R3+R4)/(R3−R4)≤1.99, which specifies a shape of the second lens L2. Within the above range of the relational expression, it is beneficial to achieving ultra-wide-angle. Optionally, a following relational expression is satisfied:—

$$6.36 \leq ( R 3 + R 4 ) / ( R 3 - R 4 ) \leq 1.59 .$$

The camera optical lens further satisfies a following relational expression: 0.02≤d3/TTL≤0.15. Within the above range of the relational expression, it is beneficial to achieving miniaturization. Optionally, a following relational expression is satisfied:

$$0.03 \leq d 3 / TTL \leq 0.12 .$$

A focal length of the third lens L3 is f3, and a following relational expression is satisfied: 1.13≤f3/f≤13.05. The system has better imaging quality and lower sensitivity by reasonable distribution of refractive power. Optionally, a following relational expression is satisfied: 1.82≤f3/f≤10.44.

The camera optical lens further satisfies a following relational expression: 0.03≤d5/TTL≤0.19. Within the above range of the relational expression, it is beneficial to achieving miniaturization. Optionally, a following relational expression is satisfied:

$$0.05 \leq d 5 / TTL \leq 0.15 .$$

A central curvature radius of the object side surface of the fourth lens L4 is R7, and a central curvature radius of the image side surface of the fourth lens L4 is R8, a following relational expression is satisfied: 0.75≤(R7+R8)/(R7−R8)≤6.43, which specifies a shape of the fourth lens L4. Within the above range of the relational expression, it is beneficial to correct the problems such as the aberration of off-axis angles with the development of ultra-thinness and wide-angle. Optionally, a following relational expression is satisfied: 1.20≤(R7+R8)/(R7−R8)≤5.14.

An on-axis thickness of the fourth lens L4 is d7, a following relational expression is satisfied: 0.04≤d7/TTL≤0.22. Within the above range of the relational expression, it is beneficial to achieving miniaturization. Optionally, a following relational expression is satisfied:

$$0.07 \leq d 7 / TTL \leq 0.17 .$$

In this embodiment, the first lens L1, the second lens L2, the third lens L3 and the fourth lens L4 are all made of plastic. In other alternative embodiments, the lenses may be made of other materials.

In this embodiment, the field of view of the camera optical lens 10 in a diagonal direction is defined as FOV, and a following relational expression is satisfied: FOV≥79.93°, which is beneficial to achieving wide-angle. Optionally, a following relational expression is satisfied: FOV≥81.56°;

An image height of the camera optical lens 10 is IH, and a following relational expression is satisfied: TTL/IH≤1.16, thereby facilitating miniaturization and ultra-thinness.

An F-number FNO of the camera optical lens is smaller than or equal to 2.45, thereby achieving large-aperture and good imaging performance of the camera optical lens.

A combined focal length of the first lens L1 and the second lens L2 is f12, and a following relational expression is satisfied: 0.42≤f12/f≤1.58, which specifies a ratio of the combined focal length f12 of the first lens L1 and the second lens L2 to the focal length f of the camera optical lens 10. Within the above range of the relational expression, aberration and distortion of the camera optical lens 10 may be eliminated, the back focal length of the camera optical lens 10 may be suppressed, and miniaturization of the camera optical lens is maintained. Optionally, a following relational expression is satisfied: 0.67≤f12/f≤1.26.

The camera optical lens of the present disclosure will be described below with Examples. The reference signs recited in each Example are shown below. The units of the focal length, the on-axis distance, the central curvature radius, and the on-axis thickness are mm.

TTL refers to a total optical length from the object side surface of the first lens to an image plane of the camera optical lens along an optic axis (the on-axis distance from the object-side surface of the first lens L1 to the image plane Si), and its unit is mm.

F-number FNO refers to a ratio of the effective focal length of the camera optical lens to the entrance pupil diameter of the camera optical lens.

The technical solutions of the present disclosure will be described in five Examples. Meanwhile, a Comparative Example is provided as a reference, and the technical effects of the present disclosure cannot be achieved when the ranges of the above relational expressions are exceeded.

### Example 1

Table 1 shows design data of the camera optical lens 10 according to Example 1 of the present disclosure.

In this Example, the second lens L2 has positive refractive power. The object side surface of the second lens L2 is convex in the paraxial region, and the image side surface of the second lens L2 is concave in the paraxial region.

TABLE 1

| | R | d | | nd | | νd | |
|---|---|---|---|---|---|---|---|
| S1 | ∞ | d0= | −0.199 | | | | |
| R1 | 0.780 | d1= | 0.360 | nd1 | 1.5439 | ν1 | 55.95 |
| R2 | 1.721 | d2= | 0.102 | | | | |
| R3 | 59.316 | d3= | 0.180 | nd2 | 1.6700 | ν2 | 19.39 |
| R4 | 91.824 | d4= | 0.194 | | | | |
| R5 | −1.354 | d5= | 0.263 | nd3 | 1.5439 | ν3 | 55.95 |
| R6 | −1.228 | d6= | 0.547 | | | | |
| R7 | 2.589 | d7= | 0.357 | nd4 | 1.5439 | ν4 | 55.95 |
| R8 | 0.968 | d8= | 0.421 | | | | |
| R9 | ∞ | d9= | 0.110 | ndg | 1.5168 | νg | 64.17 |
| R10 | ∞ | d10= | 0.186 | | | | |

The meaning of each symbol is as follows.
S1: aperture;
R: curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the optical filter GF;
R10: central curvature radius of the image side surface of the optical filter GF;
d: on-axis thickness of lenses, and on-axis distance between lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the optical filter GF to the image plane Si;
nd: refractive index of d line (d line corresponds to green light with a wavelength of 555 nm);
nd1: refractive index of d line of the first lens L1;
nd2: refractive index of d line of the second lens L2;
nd3: refractive index of d line of the third lens L3;
nd4: refractive index of d line of the fourth lens LA;
ndg: refractive index of d line of the optical filter GF;
vd: abbe number;
v1: abbe number of the first lens L1;
v2: abbe number of the second lens L2;
v3: abbe number of the third lens L3;
v4: abbe number of the fourth lens LA; and
vg: abbe number of the grating filter GF.

Table 2 shows aspheric surface data of each lens in the camera optical lens 10 according to Example 1 of the present disclosure.

TABLE 2

| | Conic coefficient | Aspherical Coefficient | | | | |
|---|---|---|---|---|---|---|
| | k | A4 | A6 | A8 | A10 | A12 |
| R1 | −1.3203E−01 | −7.4997E−02 | 3.6169E+00 | −5.9562E+01 | 7.0023E+02 | −5.6359E+03 |
| R2 | 1.8526E+00 | −1.4155E−01 | 7.3535E−01 | −5.7242E+01 | 1.1896E+03 | −1.4199E+04 |
| R3 | 9.9000E+01 | −1.8650E−01 | −3.6206E+00 | 1.0362E+02 | −1.7548E+03 | 1.8107E+04 |
| R4 | −3.6809E+01 | −1.6305E−01 | 7.7102E+00 | −1.9800E+02 | 3.4483E+03 | −3.6445E+04 |
| R5 | 5.1185E−01 | −5.3294E−01 | −1.4985E+00 | 7.1715E+01 | −9.9447E+02 | 8.4186E+03 |
| R6 | −2.2482E−01 | −5.8121E−01 | 3.2076E+00 | −8.3209E+00 | −1.0452E+01 | 2.2051E+02 |
| R7 | −9.1389E+00 | −1.4755E+00 | 2.9057E+00 | −5.1756E+00 | 6.9726E+00 | −6.0378E+00 |
| R8 | −6.3779E+00 | −8.2574E−01 | 1.4747E+00 | −1.8288E+00 | 1.3082E+00 | −4.4214E−01 |

| | Conic coefficient | Aspherical Coefficient | | | |
|---|---|---|---|---|---|
| | k | A14 | A16 | A18 | A20 |
| R1 | −1.3203E−01 | 2.9920E+04 | −9.8660E+04 | 1.8157E+05 | −1.4221E+05 |
| R2 | 1.8526E+00 | 9.8236E+04 | −3.9343E+05 | 8.4128E+05 | −7.3916E+05 |
| R3 | 9.9000E+01 | −1.1507E+05 | 4.3963E+05 | −9.3042E+05 | 8.4374E+05 |
| R4 | −3.6809E+01 | 2.4114E+05 | −9.7007E+05 | 2.1679E+06 | −2.0572E+06 |
| R5 | 5.1185E−01 | −4.5432E+04 | 1.5591E+05 | −3.1290E+05 | 2.7623E+05 |
| R6 | −2.2482E−01 | −7.8112E+02 | 1.2398E+03 | −9.3543E+02 | 2.7040E+02 |
| R7 | −9.1389E+00 | 3.2603E+00 | −1.0686E+00 | 1.9527E−01 | −1.5300E−02 |
| R8 | −6.3779E+00 | −1.6045E−02 | 6.3157E−02 | −1.8600E−02 | 1.7918E−03 |

For convenience, the aspheric surface of each lens surface uses the aspheric surface shown in the following relational expression (1). However, the present disclosure is not limited to the aspheric polynomial form shown in relational expression (1).

$$\begin{matrix}z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + \\ A 16 {r}^{16} + A 18 {r}^{18} + A 20 {r}^{20}\end{matrix} \qquad ( 1 )$$

Where k is a conic coefficient, A4, A6, A8, A10, A12, A14, A16, A18, and A20 are aspherical coefficients, c is a curvature at a center of an optical surface, r is a vertical distance between a point on an aspherical curve and an optical axis, and z is an aspherical depth (a vertical distance between a point on the aspherical surface having a distance r from the optical axis, and a tangent plane tangent to a vertex on the aspherical optical axis).

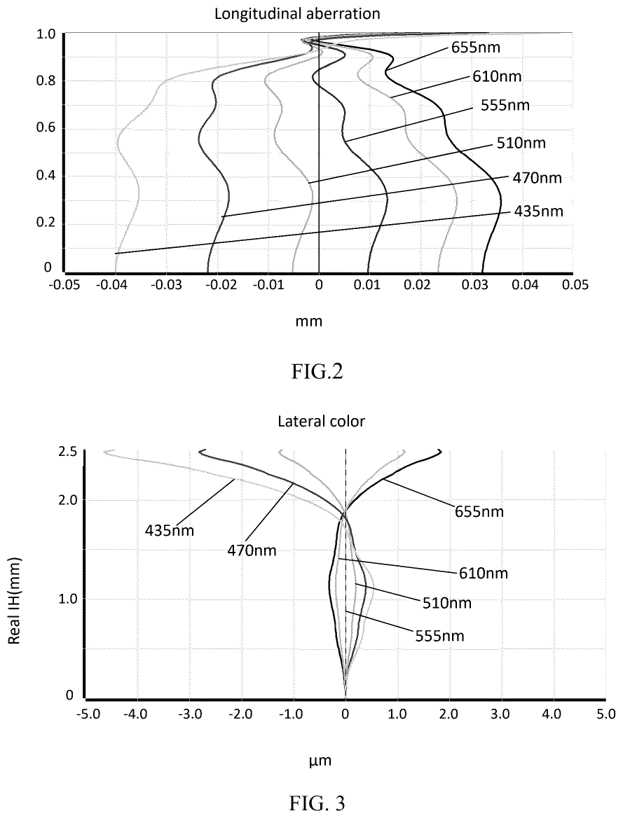

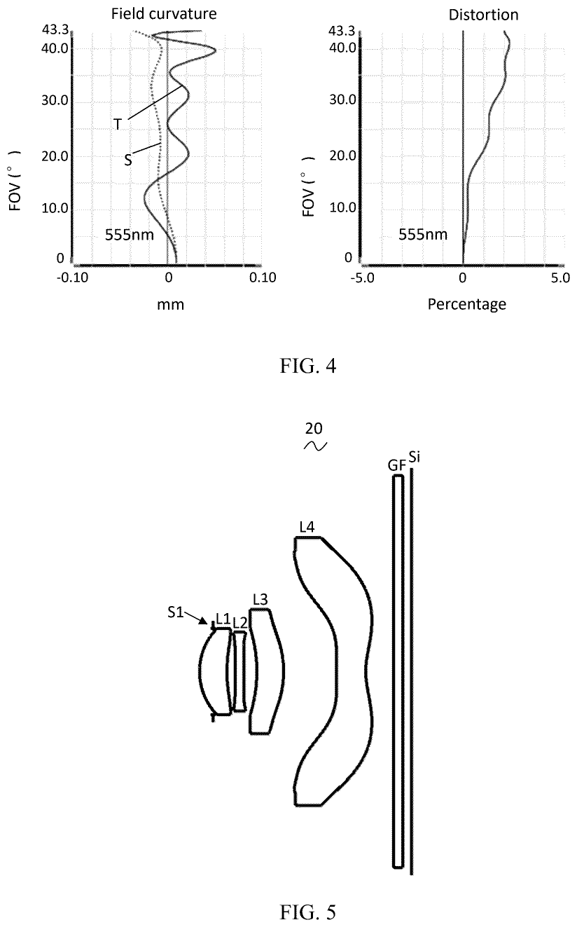

FIG. 2 and FIG. 3 show longitudinal aberration and lateral color of light with wavelengths of 435 nm, 470 nm, 510 nm, 555 nm, 610 nm and 655 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in a sagittal direction, and Tis a field curvature in a meridian direction.

Table 13 shows various values in embodiments and values corresponding to the parameters specified in the relational expressions.

As shown in Table 13, Example 1 satisfies each relational expression.

In this Example, an entrance pupil diameter ENPD of the camera optical lens 10 is 1.057 mm, a full field of view image height IH is 2.502 mm, and a field of view FOV in a diagonal direction is 86.55°, the camera optical lens 10 has large aperture and excellent optical performance, its on-axis and off-axis chromatic aberrations are fully corrected.

### Example 2

Example 2 is substantially the same as Example 1, and the reference signs have the same meaning as Example 1, and only differences are listed below.

FIG. 5 shows a camera optical lens 20 according to Example 2 of the present disclosure. The second lens L2 has negative refractive power, and an object side surface of the second lens L2 is concave in the paraxial region.

Table 3 shows design data of the camera optical lens 30 according to Example 2 of the present disclosure.

TABLE 3

| | R | d | | nd | | νd | |
|---|---|---|---|---|---|---|---|
| S1 | ∞ | d0= | −0.170 | | | | |
| R1 | 0.779 | d1= | 0.340 | nd1 | 1.5439 | ν1 | 55.95 |
| R2 | 1.729 | d2= | 0.104 | | | | |
| R3 | −24.812 | d3= | 0.104 | nd2 | 1.6700 | ν2 | 19.39 |
| R4 | 52.894 | d4= | 0.162 | | | | |
| R5 | −2.259 | d5= | 0.332 | nd3 | 1.5439 | ν3 | 55.95 |
| R6 | −1.357 | d6= | 0.656 | | | | |
| R7 | 4.596 | d7= | 0.364 | nd4 | 1.5439 | ν4 | 55.95 |
| R8 | 0.921 | d8= | 0.347 | | | | |
| R9 | ∞ | d9= | 0.110 | ndg | 1.5168 | νg | 64.17 |
| R10 | ∞ | d10= | 0.113 | | | | |

Table 4 shows aspheric surface data of each lens in the camera optical lens 20 according to Example 2 of the present disclosure.

TABLE 4

| | Conic coefficient | Aspherical Coefficient | | | | |
|---|---|---|---|---|---|---|
| | k | A4 | A6 | A8 | A10 | A12 |
| R1 | −1.2592E−01 | 4.0230E−01 | −3.3503E+01 | 9.8972E+02 | −1.4752E+04 | 1.2780E+05 |
| R2 | 1.1798E+00 | −8.0597E−01 | 4.6107E+01 | −1.4655E+03 | 2.5152E+04 | −2.5657E+05 |
| R3 | −7.7097E+02 | −1.7797E−01 | 9.9953E+00 | −4.7129E+02 | 8.2708E+03 | −7.7530E+04 |
| R4 | 1.0000E+03 | −2.4125E−01 | 1.2630E+01 | −3.8764E+02 | 7.8149E+03 | −9.5747E+04 |
| R5 | −4.2103E−01 | −2.7452E+00 | 7.8360E+01 | −1.3951E+03 | 1.5129E+04 | −1.0175E+05 |
| R6 | −3.4648E−01 | −1.0789E+00 | 1.5285E+01 | −1.2936E+02 | 6.8523E+02 | −2.2529E+03 |
| R7 | −1.0155E+01 | −1.5710E+00 | 3.2053E+00 | −5.9536E+00 | 8.0704E+00 | −6.7630E+00 |
| R8 | −6.8423E+00 | −7.8688E−01 | 1.3188E+00 | −1.5690E+00 | 1.1374E+00 | −4.6913E−01 |

| | Conic coefficient | Aspherical Coefficient | | | |
|---|---|---|---|---|---|
| | k | A14 | A16 | A18 | A20 |
| R1 | −1.2592E−01 | −6.7028E+05 | 2.0975E+06 | −3.6017E+06 | 2.6085E+06 |
| R2 | 1.1798E+00 | 1.5929E+06 | −5.9232E+06 | 1.2147E+07 | −1.0568E+07 |
| R3 | −7.7097E+02 | 4.1688E+05 | −1.2723E+06 | 2.0066E+06 | −1.2057E+06 |
| R4 | 1.0000E+03 | 7.2563E+05 | −3.2987E+06 | 8.2197E+06 | −8.6004E+06 |
| R5 | −4.2103E−01 | 4.2664E+05 | −1.0808E+06 | 1.5037E+06 | −8.7458E+05 |
| R6 | −3.4648E−01 | 4.6880E+03 | −6.0446E+03 | 4.4021E+03 | −1.3795E+03 |
| R7 | −1.0155E+01 | 3.3910E+00 | −9.7627E−01 | 1.4330E−01 | −7.5416E−03 |
| R8 | −6.8423E+00 | 8.9111E−02 | 2.5467E−03 | −3.7008E−03 | 4.1029E−04 |

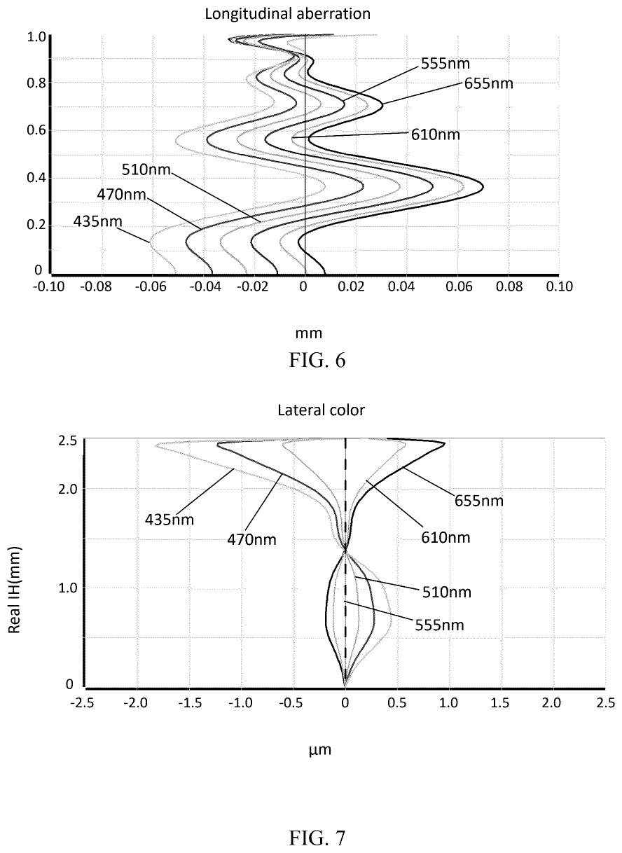

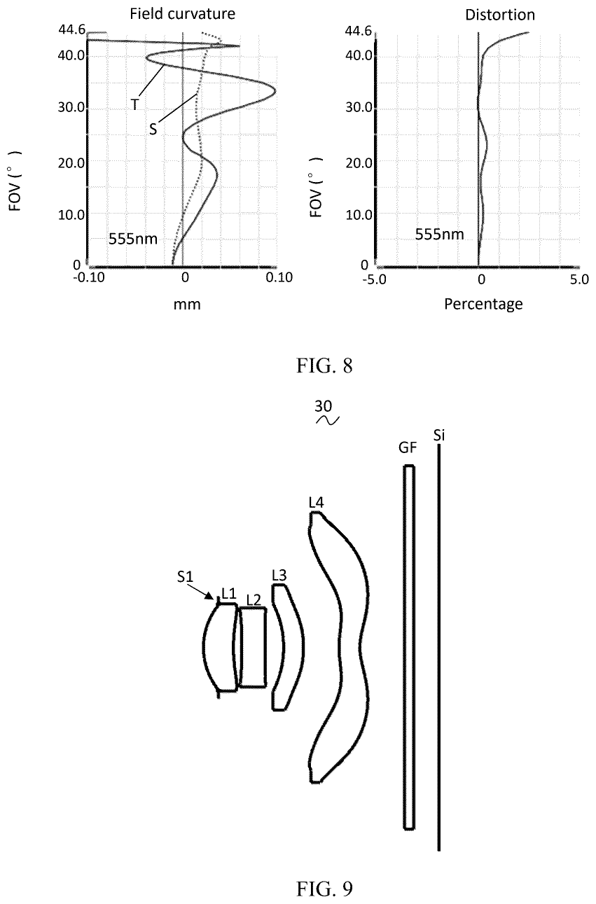

FIG. 6 and FIG. 7 show longitudinal aberration and lateral color of light with wavelengths of 435 nm, 470 nm, 510 nm, 555 nm, 610 nm and 655 nm after passing through the camera optical lens 20 according to Example 2. FIG. 8 shows field curvature and distortion of light with a wavelength of 555 nm after passing through the camera optical lens 20 according to Example 2. The field curvature S in FIG. 8 is the field curvature in the sagittal direction, and T is the field curvature in the meridian direction.

As shown in Table 13, Example 2 satisfies each relational expression.

In this Example, an entrance pupil diameter ENPD of the camera optical lens 20 is 0.992 mm, a full field of view image height IH is 2.502 mm, and a field of view FOV in a diagonal direction is 89.20°, the camera optical lens 20 has large aperture and excellent optical performance, its on-axis and off-axis chromatic aberrations are fully corrected.

### Example 3

Example 3 is substantially the same as Example 1, and the symbols have the same meaning as Example 1, and only differences are listed below.

FIG. 9 shows a camera optical lens 30 according to Example 3 of the present disclosure. The second lens L2 has negative refractive power. The object side surface of the second lens L2 is concave in a paraxial region, and the image-side surface of the second lens L2 is convex in the paraxial region.

Table 5 shows design data of the camera optical lens 50 according to Example 3 of the present disclosure.

TABLE 5

| | R | d | | nd | | νd | |
|---|---|---|---|---|---|---|---|
| S1 | ∞ | d0= | −0.184 | | | | |
| R1 | 0.819 | d1= | 0.369 | nd1 | 1.5439 | ν1 | 55.95 |
| R2 | 1.888 | d2= | 0.101 | | | | |
| R3 | −14.712 | d3= | 0.293 | nd2 | 1.6700 | ν2 | 19.39 |
| R4 | −21.910 | d4= | 0.224 | | | | |
| R5 | −1.303 | d5= | 0.245 | nd3 | 1.5439 | ν3 | 55.95 |
| R6 | −1.260 | d6= | 0.437 | | | | |
| R7 | 1.028 | d7= | 0.257 | nd4 | 1.5439 | ν4 | 55.95 |
| R8 | 0.639 | d8= | 0.553 | | | | |
| R9 | ∞ | d9= | 0.110 | ndg | 1.5168 | νg | 64.17 |
| R10 | ∞ | d10= | 0.312 | | | | |

Table 6 shows aspheric surface data of each lens in the camera optical lens 30 according to Example 3 of the present disclosure.

TABLE 6

| | Conic coefficient | Aspherical Coefficient | | | | |
|---|---|---|---|---|---|---|
| | k | A4 | A6 | A8 | A10 | A12 |
| R1 | −2.3654E−01 | −5.2455E−01 | 2.0820E+01 | −4.0856E+02 | 4.7639E+03 | −3.4365E+04 |
| R2 | 6.9076E−01 | −3.8252E−01 | 1.0449E+01 | −1.9741E+02 | 1.3526E+03 | 1.0511E+03 |
| R3 | 3.2347E+02 | −1.1346E−01 | −6.0790E+00 | 1.8632E+02 | −3.2211E+03 | 3.2591E+04 |
| R4 | 1.0008E+03 | −3.4871E−01 | 1.2532E+01 | −2.2574E+02 | 2.7464E+03 | −2.1567E+04 |
| R5 | −2.0174E−01 | 2.6094E−03 | −1.9087E+01 | 4.0581E+02 | −4.6288E+03 | 3.2862E+04 |
| R6 | 7.4099E−02 | −4.3586E−01 | −4.6699E+00 | 9.7180E+01 | −7.3005E+02 | 3.1339E+03 |
| R7 | −1.0206E+01 | −1.8667E+00 | 4.3442E+00 | −7.6491E+00 | 9.6708E+00 | −8.1358E+00 |
| R8 | −6.2292E+00 | −1.0261E+00 | 2.2610E+00 | −3.7193E+00 | 4.1639E+00 | −3.0850E+00 |

| | Conic coefficient | Aspherical Coefficient | | | |
|---|---|---|---|---|---|
| | k | A14 | A16 | A18 | A20 |
| R1 | −2.3654E−01 | 1.5467E+05 | −4.2199E+05 | 6.3747E+05 | −4.0881E+05 |
| R2 | 6.9076E−01 | −6.9629E+04 | 4.0860E+05 | −1.0150E+06 | 9.5687E+05 |
| R3 | 3.2347E+02 | −1.9845E+05 | 7.1252E+05 | −1.3868E+06 | 1.1271E+06 |
| R4 | 1.0008E+03 | 1.1006E+05 | −3.5050E+05 | 6.2752E+05 | −4.7529E+05 |
| R5 | −2.0174E−01 | −1.4830E+05 | 4.1341E+05 | −6.4837E+05 | 4.3641E+05 |
| R6 | 7.4099E−02 | −8.1185E+03 | 1.2534E+04 | −1.0646E+04 | 3.8363E+03 |
| R7 | −1.0206E+01 | 4.4188E+00 | −1.4906E+00 | 2.8427E−01 | −2.3411E−02 |
| R8 | −6.2292E+00 | 1.4769E+00 | −4.3821E−01 | 7.3208E−02 | −5.2593E−03 |

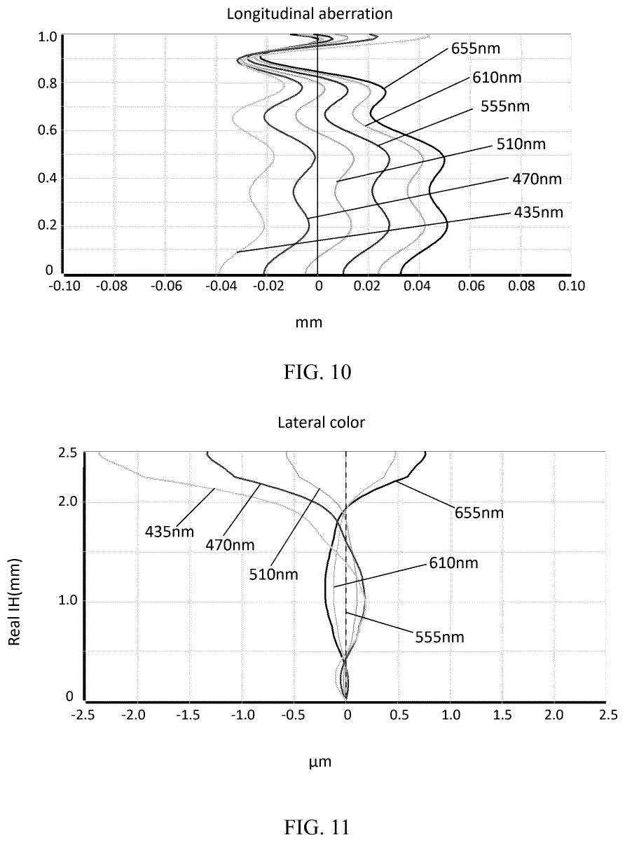

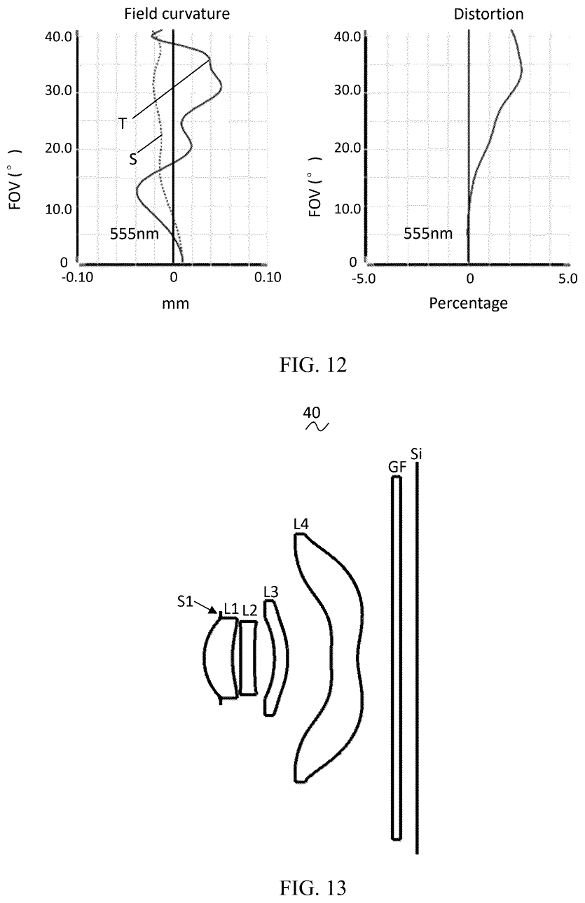

FIG. 10 and FIG. 11 show longitudinal aberration and lateral color of light with wavelengths of 435 nm, 470 nm, 510 nm, 555 nm, 610 nm and 655 nm after passing through the camera optical lens 30 according to Example 3. FIG. 12 shows field curvature and distortion of light with a wavelength of 555 nm after passing through the camera optical lens 30 according to Example 3. The field curvature S in FIG. 12 is the field curvature in the sagittal direction, and T is the field curvature in the meridian direction.

Table 13 below lists values corresponding to each conditional expression in this embodiment according to the above conditional expressions. The camera optical lens 30 of the present embodiment satisfies the above relational expressions.

In this Example, an entrance pupil diameter ENPD of the camera optical lens 30 is 1.141 mm, a full field of view image height IH is 2.502 mm, and a field of view FOV in a diagonal direction is 82.17°, the camera optical lens 30 has large aperture and excellent optical performance, its on-axis and off-axis chromatic aberrations are fully corrected.

### Example 4

Example 4 is substantially the same as Example 1, and the symbols have the same meaning as Example 1, and only differences are listed below.

FIG. 13 shows a camera optical lens 40 according to Example 4 of the present disclosure. The second lens L2 has negative refractive power.

Table 7 shows design data of the camera optical lens 40 according to Example 4 of the present disclosure.

TABLE 7

| | R | d | | nd | | νd | |
|---|---|---|---|---|---|---|---|
| S1 | ∞ | d0= | −0.214 | | | | |
| R1 | 0.757 | d1= | 0.366 | nd1 | 1.5439 | ν1 | 55.95 |
| R2 | 1.590 | d2= | 0.109 | | | | |
| R3 | 269.605 | d3= | 0.178 | nd2 | 1.6700 | ν2 | 19.39 |
| R4 | 37.534 | d4= | 0.253 | | | | |
| R5 | −1.444 | d5= | 0.171 | nd3 | 1.5439 | ν3 | 55.95 |
| R6 | −1.358 | d6= | 0.560 | | | | |
| R7 | 3.012 | d7= | 0.339 | nd4 | 1.5439 | ν4 | 55.95 |
| R8 | 0.973 | d8= | 0.446 | | | | |
| R9 | ∞ | d9= | 0.110 | ndg | 1.5168 | νg | 64.17 |
| R10 | ∞ | d10= | 0.212 | | | | |

Table 8 shows aspheric surface data of each lens in the camera optical lens 40 according to Example 4 of the present disclosure.

TABLE 8

| | Conic coefficient | Aspherical Coefficient | | | | |
|---|---|---|---|---|---|---|
| | k | A4 | A6 | A8 | A10 | A12 |
| R1 | −1.6883E−01 | −1.4089E−01 | 2.7897E+00 | −3.7848E+01 | 5.2026E+02 | −4.7701E+03 |
| R2 | 1.6336E+00 | −4.7349E−02 | 1.9532E−02 | −5.9500E+01 | 1.0790E+03 | −1.0013E+04 |
| R3 | −1.0001E+03 | 2.7638E−02 | −6.5932E+00 | 1.0927E+02 | −1.4877E+03 | 1.4776E+04 |
| R4 | −2.3206E+02 | 7.4671E−01 | −4.2402E+01 | 1.1614E+03 | −1.7454E+04 | 1.5913E+05 |
| R5 | 2.2268E−01 | −4.2453E−01 | 4.0680E+00 | −7.3458E+01 | 6.9421E+02 | −2.7846E+03 |
| R6 | −3.6038E−01 | −7.2242E−01 | 8.5511E+00 | −8.6284E+01 | 6.1051E+02 | −2.6067E+03 |
| R7 | −9.9744E+00 | −1.6831E+00 | 3.5738E+00 | −6.5747E+00 | 9.0080E+00 | −7.9392E+00 |
| R8 | −7.3408E+00 | −9.4296E−01 | 1.7656E+00 | −2.2796E+00 | 1.6998E+00 | −5.9185E−01 |

| | Conic coefficient | Aspherical Coefficient | | | |
|---|---|---|---|---|---|
| | k | A14 | A16 | A18 | A20 |
| R1 | −1.6883E−01 | 2.6304E+04 | −8.4412E+04 | 1.4557E+05 | −1.0458E+05 |
| R2 | 1.6336E+00 | 5.3006E+04 | −1.6594E+05 | 2.8850E+05 | −2.1530E+05 |
| R3 | −1.0001E+03 | −9.4078E+04 | 3.5499E+05 | −7.1988E+05 | 6.0470E+05 |
| R4 | −2.3206E+02 | −8.9844E+05 | 3.0857E+06 | −5.9359E+06 | 4.9375E+06 |
| R5 | 2.2268E−01 | 5.9502E+02 | 3.3101E+04 | −1.0534E+05 | 1.0505E+05 |
| R6 | −3.6038E−01 | 6.8289E+03 | −1.0799E+04 | 9.4234E+03 | −3.4659E+03 |
| R7 | −9.9744E+00 | 4.3621E+00 | −1.4516E+00 | 2.6857E−01 | −2.1241E−02 |
| R8 | −7.3408E+00 | −3.3243E−02 | 9.9607E−02 | −3.0577E−02 | 3.1131E−03 |

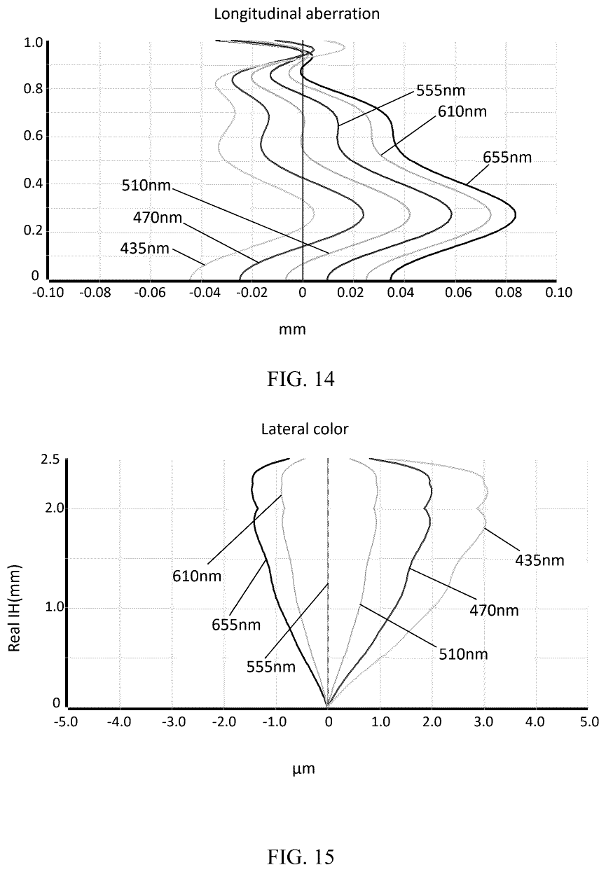

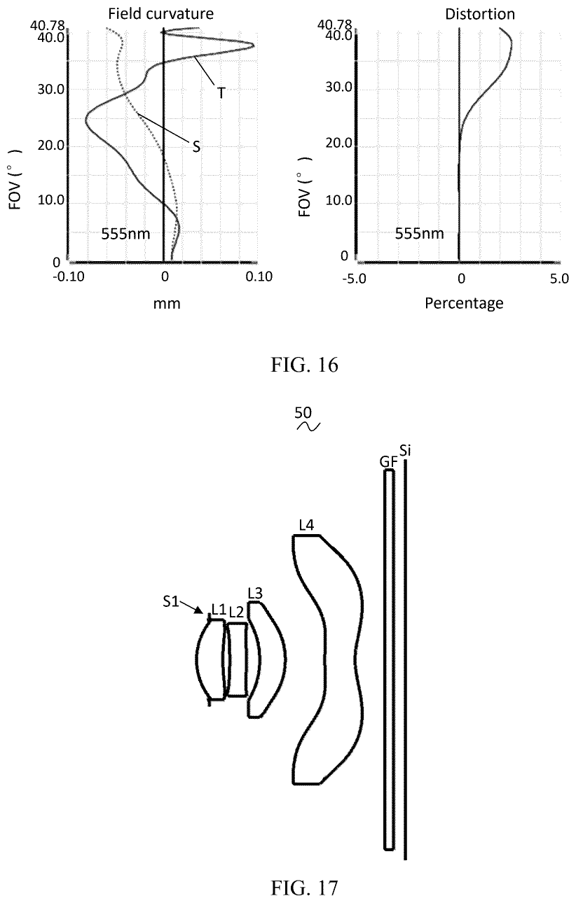

FIG. 14 and FIG. 15 show longitudinal aberration and lateral color of light with wavelengths of 435 nm, 470 nm, 510 nm, 555 nm, 610 nm and 655 nm after passing through the camera optical lens 40 according to Example 4. FIG. 16 shows field curvature and distortion of light with a wavelength of 555 nm after passing through the camera optical lens 40 according to Example 4. The field curvature S in FIG. 16 is the field curvature in the sagittal direction, and T is the field curvature in the meridian direction.

Table 13 below lists values corresponding to each conditional expression in this embodiment according to the above conditional expressions. The camera optical lens 40 of the present embodiment satisfies the above relational expressions.

In this Example, an entrance pupil diameter ENPD of the camera optical lens 40 is 1.152 mm, a full field of view image height IH is 2.502 mm, and a field of view FOV in a diagonal direction is 81.56°, the camera optical lens 40 has large aperture and excellent optical performance, its on-axis and off-axis chromatic aberrations are fully corrected.

### Example 5

Example 5 is substantially the same as Example 1, and the symbols have the same meaning as Example 1, and only differences are listed below.

FIG. 17 shows a camera optical lens 50 according to Example 5 of the present disclosure. The second lens L2 has negative refractive power. The object side surface of the second lens L2 is concave in a paraxial region, and the image-side surface of the second lens L2 is convex in the paraxial region.

Table 9 shows design data of the camera optical lens 50 according to Example 5 of the present disclosure.

TABLE 9

| | R | d | | nd | | νd | |
|---|---|---|---|---|---|---|---|
| S1 | ∞ | d0= | −0.167 | | | | |
| R1 | 0.836 | d1= | 0.346 | nd1 | 1.5439 | ν1 | 55.95 |
| R2 | 2.412 | d2= | 0.091 | | | | |
| R3 | −5.139 | d3= | 0.217 | nd2 | 1.6700 | ν2 | 19.39 |
| R4 | −8.348 | d4= | 0.176 | | | | |
| R5 | −1.232 | d5= | 0.337 | nd3 | 1.5439 | ν3 | 55.95 |
| R6 | −0.942 | d6= | 0.519 | | | | |
| R7 | 2.459 | d7= | 0.398 | nd4 | 1.5439 | ν4 | 55.95 |
| R8 | 0.945 | d8= | 0.393 | | | | |
| R9 | ∞ | d9= | 0.110 | ndg | 1.5168 | νg | 64.17 |
| R10 | ∞ | d10= | 0.158 | | | | |

Table 10 shows aspherical surface data of each lens in the camera optical lens 50 according to Example 5 of the present disclosure.

TABLE 10

| | Conic coefficient | Aspherical Coefficient | | | | |
|---|---|---|---|---|---|---|
| | k | A4 | A6 | A8 | A10 | A12 |
| R1 | −1.9680E−01 | −4.6671E−01 | 2.7906E+01 | −6.4588E+02 | 8.3464E+03 | −6.4475E+04 |
| R2 | −6.2029E−02 | 7.5957E−01 | −5.4141E+01 | 1.5775E+03 | −2.6230E+04 | 2.6060E+05 |
| R3 | 4.5371E+01 | 1.6354E+00 | −9.6889E+01 | 2.7422E+03 | −4.5777E+04 | 4.7535E+05 |
| R4 | −6.4661E+02 | −9.2842E−01 | 4.7483E+01 | −1.1820E+03 | 1.7715E+04 | −1.6328E+05 |
| R5 | 1.7357E−01 | −6.7089E−01 | 7.0141E+00 | −1.5359E+02 | 2.1418E+03 | −1.7302E+04 |
| R6 | −1.9563E−01 | 5.3573E−01 | −1.7736E+01 | 1.9472E+02 | −1.2073E+03 | 4.6045E+03 |
| R7 | −9.6070E+00 | −1.4096E+00 | 2.7152E+00 | −4.7089E+00 | 6.1951E+00 | −5.2599E+00 |
| R8 | −5.5376E+00 | −6.9403E−01 | 1.1540E+00 | −1.3897E+00 | 1.0438E+00 | −4.6788E−01 |

| | Conic coefficient | Aspherical Coefficient | | | |
|---|---|---|---|---|---|
| | k | A14 | A16 | A18 | A20 |
| R1 | −1.9680E−01 | 3.0415E+05 | −8.5891E+05 | 1.3369E+06 | −8.8828E+05 |
| R2 | −6.2029E−02 | −1.5844E+06 | 5.7575E+06 | −1.1459E+07 | 9.5998E+06 |
| R3 | 4.5371E+01 | −3.1125E+06 | 1.2486E+07 | −2.8017E+07 | 2.6945E+07 |
| R4 | −6.4661E+02 | 9.3851E+05 | −3.2773E+06 | 6.3580E+06 | −5.2513E+06 |
| R5 | 1.7357E−01 | 8.3005E+04 | −2.2609E+05 | 3.0768E+05 | −1.4730E+05 |
| R6 | −1.9563E−01 | −1.0890E+04 | 1.5648E+04 | −1.2586E+04 | 4.3589E+03 |
| R7 | −9.6070E+00 | 2.7903E+00 | −8.9872E−01 | 1.6124E−01 | −1.2380E−02 |
| R8 | −5.5376E+00 | 1.1131E−01 | −7.9582E−03 | −1.6731E−03 | 2.6526E−04 |

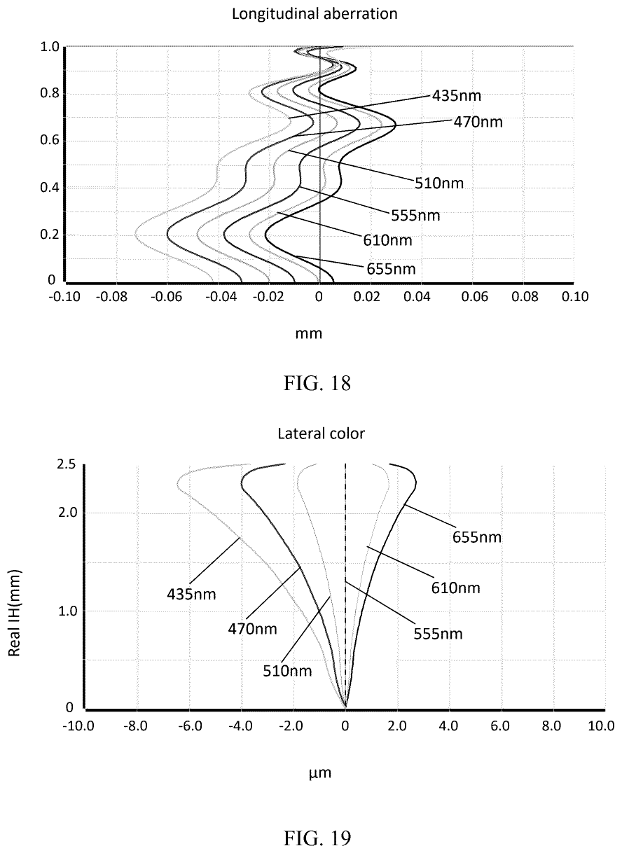

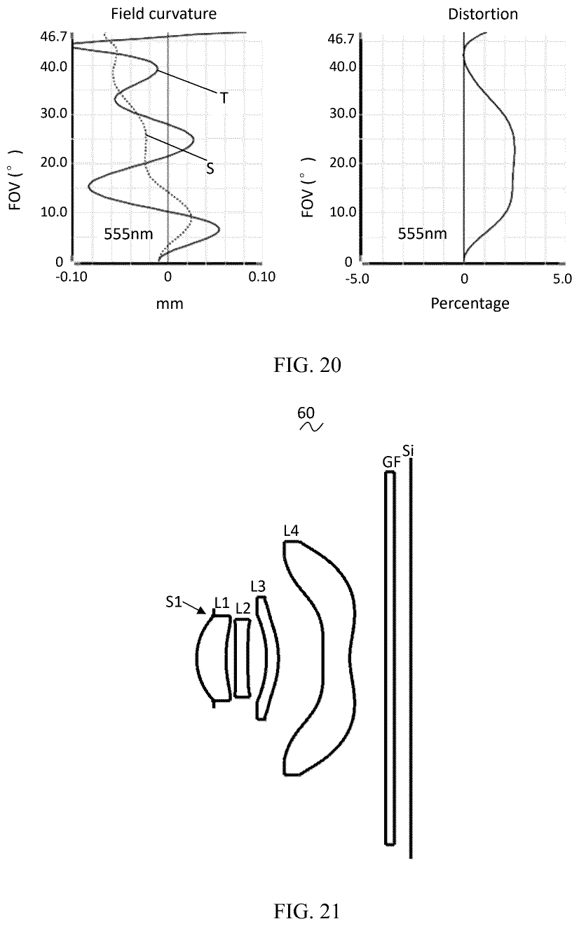

FIG. 18 and FIG. 19 show longitudinal aberration and lateral color of light with wavelengths of 435 nm, 470 nm, 510 nm, 555 nm, 610 nm and 655 nm after passing through the camera optical lens 50 according to Example 5. FIG. 20 shows field curvature and distortion of light with a wavelength of 555 nm after passing through the camera optical lens 50 according to Example 5. The field curvature S in FIG. 20 is the field curvature in the sagittal direction, and T is the field curvature in the meridian direction.

Table 13 below lists values corresponding to each conditional expression in this embodiment according to the above conditional expressions. Obviously, the camera optical lens 50 of the present embodiment satisfies the above relational expressions.

In this Example, an entrance pupil diameter ENPD of the camera optical lens 50 is 0.937 mm, a full field of view image height IH is 2.502 mm, and a field of view FOV in a diagonal direction is 93.55°, the camera optical lens 50 has large aperture and excellent optical performance, its on-axis and off-axis chromatic aberrations are fully corrected.

### COMPARATIVE EXAMPLE

The Comparative Example is basically the same as Example 1, the reference signs meaning is the same as that of Example 1, and only differences are listed below.

FIG. 21 shows a camera optical lens 60 according to Comparative Example of the present disclosure. The second lens L2 has negative refractive power.

Table 11 shows design data of the camera optical lens 60 according to Comparative Example.

TABLE 11

| | R | d | | nd | | νd | |
|---|---|---|---|---|---|---|---|
| S1 | ∞ | d0= | −0.210 | | | | |
| R1 | 0.769 | d1= | 0.362 | nd1 | 1.5439 | ν1 | 55.95 |
| R2 | 1.659 | d2= | 0.118 | | | | |
| R3 | 41.053 | d3= | 0.154 | nd2 | 1.6700 | ν2 | 19.39 |
| R4 | 30.630 | d4= | 0.229 | | | | |
| R5 | −1.411 | d5= | 0.147 | nd3 | 1.5439 | ν3 | 55.95 |
| R6 | −1.323 | d6= | 0.546 | | | | |
| R7 | 2.931 | d7= | 0.334 | nd4 | 1.5439 | ν4 | 55.95 |
| R8 | 0.948 | d8= | 0.441 | | | | |
| R9 | ∞ | d9= | 0.110 | ndg | 1.5168 | νg | 64.17 |
| R10 | ∞ | d10= | 0.206 | | | | |

Table 12 shows aspheric surface data of each lens in the camera optical lens 60 according to the Comparative Example of the present disclosure.

TABLE 12

| | Conic coefficient | Aspherical Coefficient | | | | |
|---|---|---|---|---|---|---|
| | k | A4 | A6 | A8 | A10 | A12 |
| R1 | −1.6861E−01 | 2.4000E−02 | 1.2193E+00 | −2.2217E+01 | 3.0704E+02 | −2.7361E+03 |
| R2 | 2.1129E+00 | −1.2818E−02 | 6.6425E−02 | −4.7588E+01 | 1.0032E+03 | −1.2045E+04 |
| R3 | 8.5623E+02 | −1.5158E−01 | 2.3215E+00 | −5.9507E+01 | 3.6033E+02 | 2.9619E+03 |
| R4 | −6.4418E+02 | 7.0189E−01 | −2.4645E+01 | 4.6688E+02 | −4.4747E+03 | 2.3088E+04 |
| R5 | −8.1911E−01 | −1.0679E+00 | 2.9781E+01 | −5.4487E+02 | 5.7529E+03 | −3.5372E+04 |
| R6 | −5.4446E−01 | −7.6948E−01 | 3.0504E+00 | 2.5722E+01 | −3.1409E+02 | 1.6540E+03 |
| R7 | −1.5110E+01 | −1.9646E+00 | 5.5105E+00 | −1.3726E+01 | 2.2755E+01 | −2.3043E+01 |
| R8 | −7.3588E+00 | −9.4084E−01 | 1.3800E+00 | −5.2714E−01 | −2.0150E+00 | 3.6965E+00 |

| | Conic coefficient | Aspherical Coefficient | | | |
|---|---|---|---|---|---|
| | k | A14 | A16 | A18 | A20 |
| R1 | −1.6861E−01 | 1.4973E+04 | −4.8627E+04 | 8.5756E+04 | −6.3432E+04 |
| R2 | 2.1129E+00 | 8.1938E+04 | −3.1793E+05 | 6.5499E+05 | −5.5452E+05 |
| R3 | 8.5623E+02 | −5.0532E+04 | 2.6676E+05 | −6.3388E+05 | 5.7871E+05 |
| R4 | −6.4418E+02 | −5.1813E+04 | −3.0665E+04 | 3.4566E+05 | −4.1651E+05 |
| R5 | −8.1911E−01 | 1.2752E+05 | −2.5794E+05 | 2.5298E+05 | −7.5140E+04 |
| R6 | −5.4446E−01 | −4.9270E+03 | 8.4617E+03 | −7.8766E+03 | 3.1084E+03 |
| R7 | −1.5110E+01 | 1.4324E+01 | −5.3702E+00 | 1.1181E+00 | −9.9479E−02 |
| R8 | −7.3588E+00 | −2.9074E+00 | 1.2157E+00 | −2.6329E−01 | 2.3261E−02 |

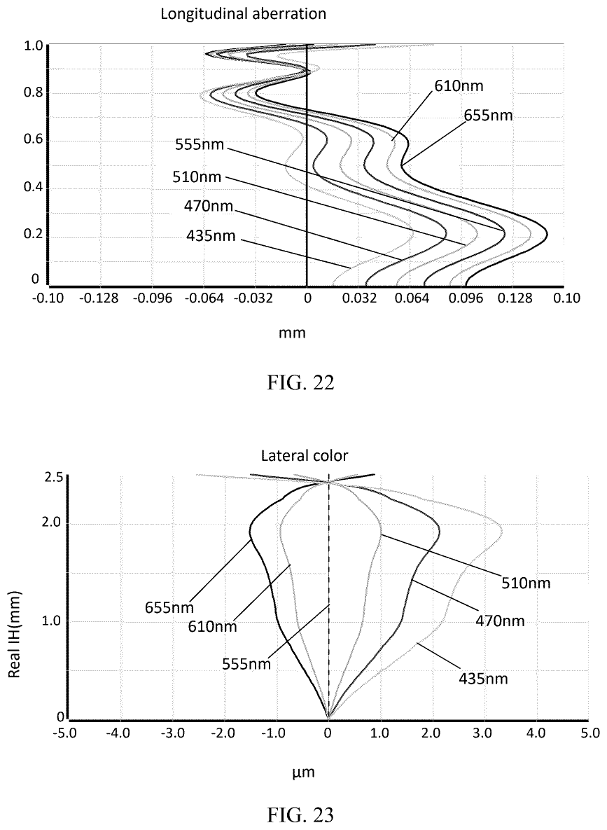

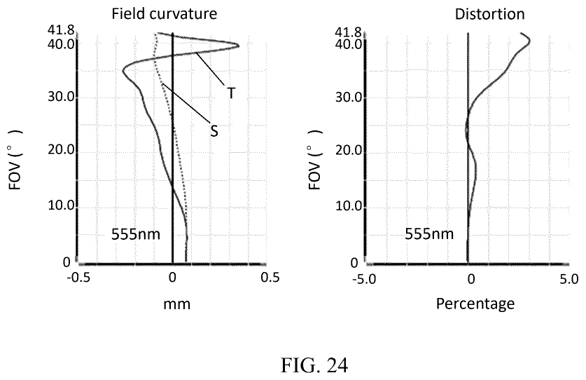

FIG. 22 and FIG. 23 show longitudinal aberration and lateral color of light with wavelengths of 435 nm, 470 nm, 510 nm, 555 nm, 610 nm, and 655 nm after passing the camera optical lens 60 according to Comparative Example. FIG. 24 shows field curvature and distortion of light with a wavelength of 555 nm after passing through the camera optical lens 60 according to Comparative Example. The field curvature S in FIG. 24 is the field curvature in the sagittal direction, and T is the field curvature in the meridian direction.

In this Example, an entrance pupil diameter ENPD of the camera optical lens 60 is 1.152 mm, a full field of view image height IH is 2.502 mm, and a field-of-view FOV in the diagonal direction is 83.29°.

Table 13 below lists values corresponding to each relational expression in Comparative Example according to the above relational expressions. Obviously, the camera optical lens 60 of Comparative Example does not satisfy the above conditional expression 0.97≤TTL/f≤1.20, and cannot achieve miniaturization and maintain excellent optical performance.

TABLE 13

| Parameters and | | | | | | |
|---|---|---|---|---|---|---|
| Relational | | | | | | Comparative |
| Expressions | Example 1 | Example 2 | Example 3 | Example 4 | Example 5 | Example |
| d6/TTL | 0.201 | 0.249 | 0.151 | 0.204 | 0.189 | 0.206 |
| f1/f | 0.889 | 0.950 | 0.845 | 0.813 | 0.949 | 0.816 |
| TTL/f | 1.051 | 1.084 | 1.038 | 0.973 | 1.196 | 0.939 |
| (R5 + R6)/ | 20.492 | 4.009 | 59.605 | 32.581 | 7.497 | 31.068 |
| (R5 − R6) | | | | | | |
| d3/d5 | 0.684 | 0.313 | 1.196 | 1.041 | 0.644 | 1.048 |
| f12 | 2.283 | 2.488 | 2.444 | 2.353 | 2.413 | 2.317 |
| f | 2.588 | 2.428 | 2.794 | 2.820 | 2.295 | 2.819 |
| f1 | 2.302 | 2.306 | 2.362 | 2.292 | 2.177 | 2.299 |
| f2 | 247.231 | −24.963 | −67.329 | −64.505 | −20.329 | −179.484 |
| f3 | 13.963 | 5.517 | 23.266 | 24.540 | 5.207 | 24.501 |
| f4 | −3.070 | −2.186 | −4.033 | −2.800 | −3.100 | −2.729 |
| FNO | 2.448 | 2.448 | 2.449 | 2.448 | 2.449 | 2.447 |
| TTL | 2.720 | 2.632 | 2.901 | 2.744 | 2.745 | 2.647 |

Those skilled in the art can understand that the above embodiments are specific embodiments for implementing the present disclosure, and in practical applications, various changes may be made in form and detail without departing from the spirit and scope of the present disclosure.

What is claimed is:

1. A camera optical lens, comprising, from an object side to an image side: a first lens having positive refractive power, a second lens having refractive power, a third lens having positive refractive power, and a fourth lens having negative refractive power;
wherein a focal length of the camera optical lens is defined as f, a total optical length from an object side surface of the first lens to an image plane of the camera optical lens along an optic axis is defined as TTL, a focal length of the first lens is defined as f1, an on-axis thickness of the second lens is defined as d3, an on-axis thickness of the third lens is d5, an on-axis distance from an image side surface of the third lens to an object side surface of the fourth lens is defined as d6, a central curvature radius of an object side surface of the third lens is defined as R5, and a central curvature radius of an image side surface of the third lens is defined as R6, and following relational expressions are satisfied:
$$\begin{matrix}0.15 \leq d6 / TTL \leq 0.25 \\ 0.8 \leq f 1 / f \leq 0.95 \\ 0.97 \leq TTL / f \leq 1.2 ; \\ 4. \leq ( R 5 + R 6 ) / ( R 5 - R 6 ) \leq 60. ; and \\ 0.3 \leq d 3 / d 5 \leq 1.2 .\end{matrix}$$

2. The camera optical lens as described in claim 1, wherein a focal length of the fourth lens is f4, and a following relational expression is satisfied:
$$- 1.4 \leq f 4 / f \leq - 0.90 .$$

3. The camera optical lens as described in claim 1, wherein a central curvature radius of an object side surface of the fourth lens is defined as R7, a central curvature radius of an image side surface of the fourth lens is defined as R8, and a following relational expression is satisfied:
$$1.5 \leq R 7 / R 8 \leq 5. .$$

4. The camera optical lens as described in claim 1, wherein an object side surface of the first lens is convex in a paraxial region, and an image side surface of the first lens is concave in the paraxial region; and
an on-axis thickness of the first lens is defined as d1, a central curvature radius of an object side surface of the first lens is defined as R1, a central curvature radius of an image side surface of the first lens is defined as R2, and following relational expressions are satisfied:
$$\begin{matrix}- 5.64 \leq ( R 1 + R 2 ) / ( R 1 - R 2 ) \leq - 1 \text{.37} ; and \\ 0.06 \leq d 1 / TTL \leq 0.20 .\end{matrix}$$

5. The camera optical lens as described in claim 1, wherein a focal length of the second lens is defined as f2, a central curvature radius of an object side surface of the second lens is defined as R3, a central curvature radius of an image side surface of the second lens is defined as R4, and following relational expressions are satisfied:
$$\begin{matrix}- 48.2 \leq f 2 / f \leq 143.29 ; \\ - 10. 18 \leq ( R 3 + R 4 ) / ( R 3 - R 4 ) \leq 1.99 ; and \\ 0.02 \leq d 3 / TTL \leq 0.15 .\end{matrix}$$

6. The camera optical lens as described in claim 1, wherein an object side surface of the third lens is concave in a paraxial region, and an image side surface of the third lens is convex in the paraxial region;
a focal length of the third lens is f3, and following relational expressions are satisfied:
$$\begin{matrix}1.13 \leq f3 / f \leq 13.05 ; and \\ 0.03 \leq d 5 / TTL \leq 0.19 .\end{matrix}$$

7. The camera optical lens as described in claim 1, wherein an object side surface of the fourth lens is convex in a paraxial region, and an image side surface of the fourth lens is concave in the paraxial region;
a central curvature radius of an object-side surface of the fourth lens is R7, a central curvature radius of an image-side surface of the fourth lens is R8, and an on-axis thickness of the fourth lens is d7, and following relational expressions are satisfied:
$$\begin{matrix}0.75 \leq ( R 7 + R 8 ) / ( R 7 - R 8 ) \leq 6.43 ; and \\ 0.04 \leq d 7 / TTL \leq 0.22 .\end{matrix}$$

8. The camera optical lens as described in claim 1, wherein an F-number FNO of the camera optical lens is smaller than or equal to 2.45.

9. The camera optical lens as described in claim 1, wherein an image height of the camera optical lens is IH, and a following relational expression is satisfied:
$$TTL / IH \leq 1.16 .$$

10. The camera optical lens as described in claim 1, wherein a combined focal length of the first lens and the second lens is f12, and a following relational expression is satisfied:
$$0.42 \leq f 12 / f \leq 1.58 .$$
